(19) United States
(12) Patent Application Publication
(10) Pub. No.: US 2008/0151472 A1
(43) Pub. Date: Jun. 26, 2008

(54) ELECTROCHEMICAL DOUBLE LAYER CAPACITOR

(76) Inventors: Yuriy A. Maletin, Kiev (UA); Sergiy M. Podmogilny, Kiev (UA); Natalya G. Stryzhakova, Kiev (UA); Antonina A. Mironova, Kiev (UA); Valeriy V. Danylin, Kiev (UA); Andrey Y. Maletin, Kiev (UA)

Correspondence Address: LAW OFFICE OF PETER G. KORYTNYK, PLLC, 213 S. Payne Street, Alexandria, VA, 22314, US

(21) Appl. No.: 11/959,912

(22) Filed: Dec. 19, 2007

Related U.S. Application Data
(60) Provisional application No. 60/875,857, filed on Dec. 20, 2006.

(51) Int. Cl. H01G 9/004

(52) U.S. Cl. 361/502

(57) ABSTRACT

An electrochemical double layer capacitor (EDLC) is provided. The EDLC can include first and second multi-layered polarizable electrodes arranged within a casing. Each multi-layered polarizable electrode can include a nanoporous carbon layer and a metal current collector layer including a metal substrate having a first surface and a second surface. The first surface can be covered by the nanoporous carbon layer. An organic electrolyte can be impregnated within the nanoporous carbon layer. The first surface of the metal substrate can include a plurality of conductive carbon particles each (i) being locally and individually fused into the first surface of the metal substrate by spot melting an area on the first surface of the metal substrate, (ii) projecting out of the first surface, and (iii) surrounded by a flowed surface of the metal substrate. The plurality of conductive carbon particles are at least one of graphite, carbon black, and acetylene black particles

### CROSS-REFERENCE TO RELATED APPLICATION

This application claims priority under 35 U.S.C. 119(e) to U.S. Provisional Patent Application Ser. No. 60/875,857, filed Dec. 20, 2006, the contents of which are hereby incorporated by reference.

### FIELD OF THE INVENTION

The present teachings relate to an electrochemical double layer capacitor (EDLC). In particular, the present teachings relate to an EDLC including multi-layered polarizable electrodes that are capable of increasing energy and power density of the EDLC.

### BACKGROUND OF THE INVENTION

Electrochemical double layer capacitors (EDLCs), also known as ultracapacitors or supercapacitors, are efficient energy storage devices. In order to increase energy and power density, a known aim of EDLC design is to lower inner resistance and increase working voltage and working time. However, as set forth below, various obstacles have been encountered in achieving these goals.

One obstacle has been the availability of an insulating oxide film on the metal current collectors of the polarizable electrodes of the EDLC. This insulating oxide film increases contact resistance between a nanoporous carbon layer and the metal current collector of the polarizable electrode. The increased contact resistance contributes to an increased inner resistance and correspondingly to a lower output power density and lower efficiency of the EDLC.

Known are attempts to eliminate negative effect of an oxide film by embedding carbon particles into an aluminum current collector using known mechanical treatments such as pressing, ultrasonic treatment, and the like. See for example, U.S. Pats. Nos. 6,447,555 and 6,808,845. Nevertheless these known attempts did not provide desirable results. It is also known to heat an aluminum current collector up to its melting point using, for example, resistive heating, and then to press a carbon electrode into the melt. However, this requires a large amount of energy since aluminum melts at about 660° C. Moreover, such a method cannot be used with relatively thin aluminum current collectors that are typically used in EDLC technology.

The resistivity of a nanoporous carbon powder used to create the nanoporous carbon layer of the polarizable electrodes also significantly contributes to the inner resistance of EDLCs. The resistivity of the nanoporous carbon powder is another obstacle encountered in reducing the inner resistance of EDLCs.

Yet another obstacle is the electrochemical corrosion of the metal parts (for example, current collectors and terminals) of the EDLC. More particularly, the intensity of electrochemical corrosion of the positive electrodes of the EDLC can be significant due to anodic corrosion. Even valve metals, such as, aluminum, which are widely used in EDLC technologies, suffer from such electrochemical corrosion. The electrochemical corrosion of parts of the EDLC can undesirably lower the working voltage of the EDLC.

Accordingly, there exists a need for an EDLC that possesses a reduced inner resistance and an increased working voltage compared to currently known EDLCs to thereby achieve increased output power density and efficiency.

### SUMMARY OF THE INVENTION

The present teachings provide an electrochemical double layer capacitor and a metal current collector layer of an electrode of an electrochemical double layer capacitor.

According to an embodiment, an electrochemical double layer capacitor can include a casing, and a first multi-layered polarizable electrode and a second multi-layered polarizable electrode arranged within the casing. Each multi-layered polarizable electrode can include a nanoporous carbon layer and a metal current collector layer including a metal substrate having a first surface and a second surface. The first surface can be covered by the nanoporous carbon layer. A first capacitor terminal can be connected to the first multi-layered polarizable electrode and a second capacitor terminal can be connected to the second multi-layered polarizable electrode. An organic electrolyte can be impregnated in the nanoporous carbon layer. The first surface of the metal substrate can include a plurality of conductive carbon particles each (i) being locally and individually fused into the first surface of the metal substrate by spot melting an area on the first surface of the metal substrate, (ii) projecting out of the first surface, and (iii) surrounded by a flowed surface of the metal substrate. The plurality of conductive carbon particles are at least one of graphite, carbon black, and acetylene black particles.

According to another embodiment, an electrochemical double layer capacitor can include a casing, and a first multi-layered polarizable electrode and a second multi-layered polarizable electrode arranged within the casing. Each multi-layered polarizable electrode can include a nanoporous carbon layer and a metal current collector layer including a metal substrate having a first surface and a second surface. The first surface can be covered by the nanoporous carbon layer. A first capacitor terminal can be connected to the first multi-layered polarizable electrode and a second capacitor terminal can be connected to the second multi-layered polarizable electrode. An organic electrolyte can be impregnated in the nanoporous carbon layer. The nanoporous carbon powder can be made of an activated carbon produced of a natural bituminous carbon material that has been treated by polycarboxilic acid, filtered, and heated.

According to yet another embodiment, a metal current collector layer of an electrode can include a metal substrate having a first surface and a second surface. At least the first surface of the metal substrate can include a plurality of conductive carbon particles each being locally and individually fused into the surface by spot melting an area on the first surface. The plurality of conductive carbon particles can project out of the surface and can be surrounded by a flowed surface of the metal substrate.

Additional features and advantages of various embodiments will be set forth, in part, in the description that follows, and will, in part, be apparent from the description, or may be learned by the practice of various embodiments. The objectives and other advantages of various embodiments will be realized and attained by means of the elements and combinations particularly pointed out in the description herein.

### BRIEF DESCRIPTION OF THE DRAWINGS

FIG. 1 is a cross-sectional side view of an EDLC according to various embodiments;

FIG. 2 is a cross-sectional side view of a portion of a polarizable electrode of an EDLC, namely of a metal substrate of a metal current collector layer with fused conductive carbon particles on one side thereof according to various embodiments;

FIG. 3 is a cross-sectional side view of a portion of a polarizable electrode of an EDLC, namely of a metal substrate of a metal current collector layer with fused conductive carbon particles on both sides thereof according to various embodiments;

FIG. 4 is a photograph of a surface of the metal current collector layer of a polarizable electrode at 220× magnification;

FIG. 5 is an exploded portion of area A of FIG. 1 and shows a cross-sectional side view of an embodiment of a polarizable electrode;

FIG. 6 is an exploded portion of area A of FIG. 1 and shows a cross-sectional side view of another embodiment of a polarizable electrode;

FIG. 7 is a schematic diagram of an electric-spark device and arrangement according to various embodiments;

FIG. 8 is a schematic diagram of an arrangement for measuring the resistivity of a polarizable electrode according to various embodiments;

FIG. 9 is a graph showing cyclic voltammetry curves of metal current collectors of an exemplary EDLC according to various embodiments; and

FIG. 10 is a graph showing cyclic voltammetry curves of metal current collectors of another exemplary EDLC according to various embodiments.

It is to be understood that both the foregoing general description and the following detailed description are exemplary and explanatory only, and are intended to provide an explanation of various embodiments of the present teachings.

### DETAILED DESCRIPTION OF THE PREFERRED EMBODIMENTS

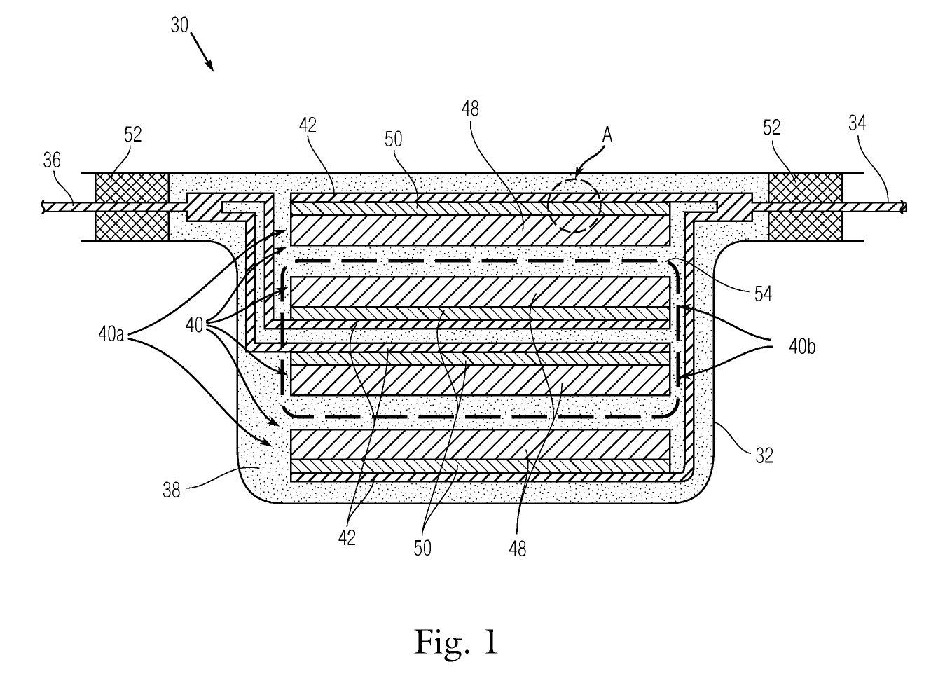

Referring to FIG. 1, a cross-section through an electrochemical double layer capacitor (EDLC) 30 of the present teachings is shown. The EDLC 30 can include a capacitor casing 32 that houses a plurality of multi-layered polarizable electrodes 40. The EDLC 30 can include a first polarizable electrode set 40a and a second polarizable electrode set 40b, each set 40a, 40b including a pair of multi-layered polarizable electrodes 40. A first capacitor terminal 34 can be connected with the first polarizable electrode set 40a and a second capacitor terminal 36 can be connected with the second polarizable electrode set 40b. Within the casing 32 of the EDLC 30, an electrolyte 38 can be provided that surrounds and impregnates the plurality of polarizable electrodes 40.

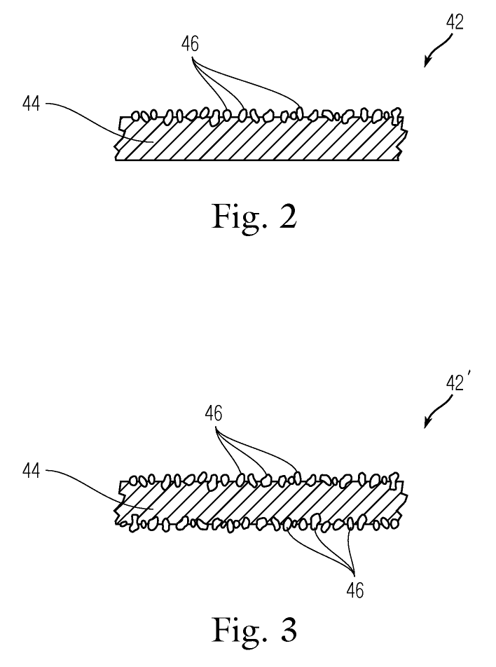

FIG. 2 shows a portion of one of the polarizable electrodes 40 of the EDLC 30 of the present teachings, namely a metal current collector layer 42 including a metal substrate 44. The metal substrate 44 can be made of any metal. Preferably, the metal substrate 44 can be made of aluminum and can be in the form of an aluminum foil.

A plurality of conductive carbon particles 46 can be partially fused into a surface of the metal substrate 44. The fused particles can occupy a first surface of the metal substrate 44 which is limited by the outermost particles fused. According to various embodiments, individual carbon particles 46 can each be separately and locally fused into the surface of the metal substrate 44. As a result of such local fusion, a portion of each carbon particle projects out of the surface of the metal substrate 44 and is surrounded by the flowed surface of the metal substrate 44, the rest surface of the metal substrate 44 remaining unchanged.

As will be discussed in more detail below, local fusion of each carbon particle proceeds by melting a localized spot on a surface of the metal substrate 44. Such localized melting can be achieved by way of an electric spark or a laser beam, for example. Localized melting of the surface of the metal substrate 44 can be followed by the fusing an individual carbon particle 46 into the melted spot, such that an embedded portion of the individual carbon particle 46 is surrounded by the melted, flowable material of the metal substrate 44. After cooling, the individual fused carbon particle 46 is surrounded by the flowed surface of the metal substrate 44.

According to various embodiments, a controlled fusing of each carbon particle can be achieved such that a controlled, particularly substantially uniform distribution of the fused particles over the surface of the metal substrate 44 can be provided. In this manner, a plurality of carbon particles 46 can be separately and individually fused into the metal substrate 44. The formation of an oxide film between the metal and the embedded portion of the carbon particles can be eliminated by way of this local fusion process which results in a much lower contact resistance between the metal substrate 44 and the conductive carbon particles 46.

By partially embedding the conductive carbon particles 46 into the surface of the metal substrate 44 by way of local fusion, in addition to elimination of an oxide film, a contact area between the surface of the metal substrate 44 and the surface of the conductive carbon particles 46 can be increased. This increased contact area also reduces the contact resistance between the metal substrate 44 and the conductive carbon particles 46. By reducing this contact resistance, the inner resistance of the EDLC 30 can be reduced which thereby increases the output power density and the efficiency of the EDLC 30. A lower contact resistance can also be achieved between the metal substrate 44 and a nanoporous carbon layer 48, which will be described below. Local fusion allows the use of a relatively thin metal substrate 44.

The plurality of conductive carbon particles 46 can be of any carbon containing material that is conductive. Preferably, the plurality of conductive carbon particles 46 can include one of graphite particles, carbon black particles, and acetylene black particles, or combinations thereof.

FIG. 3 shows an alternative embodiment of a metal current collector layer 42 of the EDLC 30 of the present teachings. The metal current collector layer 42′ can include a plurality of conductive carbon particles 46 that have been partially embedded into both surfaces of a metal substrate 44 by way the local fusion process as described above.

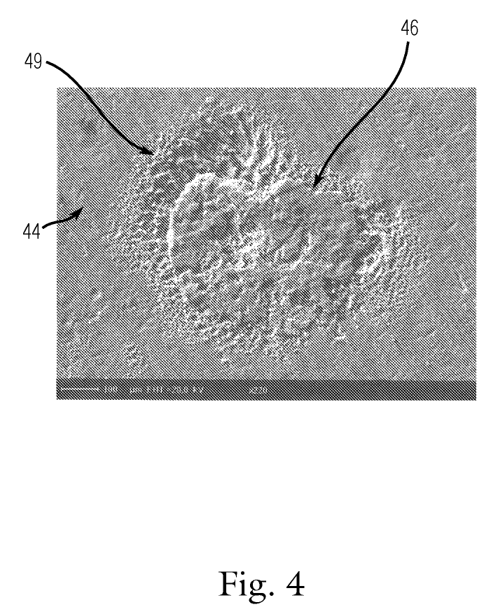

FIG. 4 shows a magnified view of an individual highly conductive carbon particle 46 partially embedded into a surface of a metal substrate 44, partially projecting out of the surface and surrounded by a flowed surface 49 of the metal substrate 44.

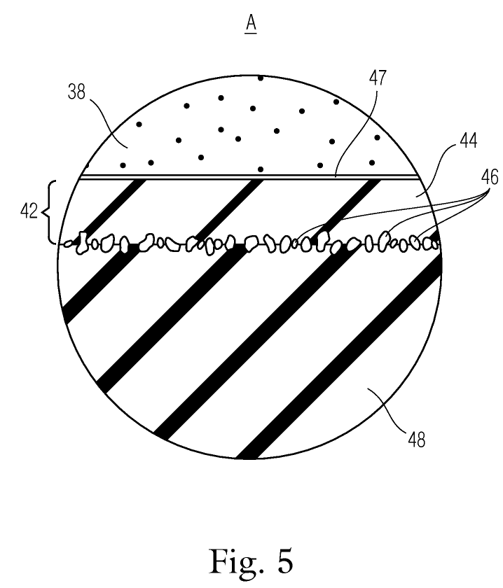

Referring to FIG. 5, an exploded portion of area A of FIG. 1 is shown and corresponds to a cross-sectional side view of one embodiment of a polarizable electrode 40. The polarizable electrode 40 includes a nanoporous carbon layer 48 arranged on the side of the metal current collector layer 42 which has been embedded with the conductive carbon particles 46 by local fusion. The protruding portions of the fused carbon particles 46 provide an effective electrical contact between the metal substrate 44 and the nanoporous carbon layer 48 thereby reducing contact resistance therebetween. By reducing the contact resistance between the metal substrate 44 and the nanoporous carbon layer 48, the inner resistance of the EDLC 30 can be lowered.

The nanoporous carbon layer 48 can be made of a nanoporous carbon powder that can be made from an activated carbon produced from a natural bituminous carbon material. However, the activated carbon powder can include about 0.5 wt. % impurities, such as iron oxides and other iron compounds. During the activation process, the impurities form an oxygen-containing group, such as carbonyl, hydroxide, ether, and the like on the surface of the activated carbon. The iron compounds and oxygen-containing impurities increase the self-discharge of the EDLC 30 and shorten its lifetime. Furthermore, these impurities increase electrical resistance of the nanoporous carbon layer 48. Accordingly, iron compounds and oxygen-containing impurities are strongly undesirable in the EDLC 30.

The impurities of the activated carbon produced from a natural bituminous carbon material can be removed by treating the activated carbon with polycarboxilic acid and then filtering the treated activated carbon in order to collect the remaining residue. The remaining residue can then be heated at a temperature of from about 600° C. to about 1200° C. under an inert atmosphere. Preferably, the remaining residue can be heated at a temperature of from about 700° C. to about 1000° C. This heating process can remove the oxygen-containing surface groups and can increase the graphitization of the nanoporous carbon powder. Increased graphitization reduces the resistivity of the nanoporous carbon layer 48 thereby lowering the inner resistance of the EDLC 30.

The particles of the nanoporous carbon powder can have an average pore diameter of from about 1 nm to about 3 nm.

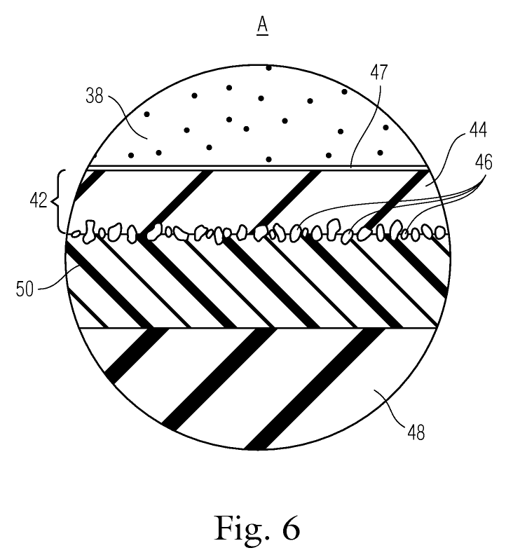

According to various embodiments and as shown in FIG. 5, the nanoporous carbon layer 48 can be deposited directly onto the metal current collector layer 42, namely onto the first surface of the metal substrate 44 which has been fused with the conductive carbon particles 46. Alternatively, the nanoporous carbon layer 48 can be deposited directly onto a surface of the metal current collector layer 42 which has not been embedded with any particles. Furthermore, according to various embodiments and as shown in FIG. 6, the nanoporous carbon layer 48 can be deposited onto an additional conductive layer 50 of the metal current collector layer 42 which will be described in detail below.

As shown in FIG. 6, the conductive layer 50 can be positioned on the metal current collector layer 42 to be between the nanoporous carbon layer 48 and the metal substrate 44 which has been embedded with conductive carbon particles 46. The conductive layer 50 can include a composition that is chemically and electrochemically stable when it comes into contact with the electrolyte 38 surrounding the electrodes 40 of the EDLC 30, and protective against electrochemical corrosion in the organic electrolyte 38. For example, the conductive layer 50 can include a conductive carbon powder with a binder that does not dissolve in or react with the electrolyte 38 of the EDLC 30 and creates a protective film that does not allow the electrolyte to penetrate through it and does not undergo an electrochemical transformation when a voltage is applied to the metal current collector layer 42 of the electrode 40. As a result, the conductive layer 50 can conduct electricity and simultaneously can also protect the first surface of the metal substrate 44 of EDLC 30. In this manner, the conductive layer 50 can spread electric current to a greater volume of the nanoporous carbon layer thereby reducing the resistance of the polarizable electrode 40 and can reduce corrosion of the polarizable electrode 40 thereby increasing the working voltage and working time of the EDLC 30.

The conductive carbon powder of the conductive layer 50 can include graphite powder, carbon black, and/or acetylene black. The binder of the conductive layer 50 can be a polymer capable of adhering to the metal substrate 44, the fused carbon particles 46 and the nanoporous layer 48. Preferably, the content of the conductive carbon powder in the composition of the conductive layer 50 is from about 20 wt. % to about 80 wt. % and, more preferably, is from about 30 wt. % to about 60 wt. %.

A preferable organic electrolyte especially suitable for use with the nanoporous carbon powder, made from an activated carbon produced from natural bituminous carbon material in as described above, are electrolytes based on tetrakis(dialkylamino)phosphonium or tetraalkylammonium tetrafluoroborates or hexafluorophosphates or their mixtures dissolved in a polar aprotic solvent or in the mixture of solvents selected from nitrites (acetonitrile, propionitrile, 3-methoxy propionitrile), lactones (γ-butyrolactone, γ-valerolactone), carbonates (propylene carbonate, ethylene carbonate, ethyl methyl carbonate), N,N-dimethylformamide, 1-methyl-2-pyrrolidinone, methyl ethyl ketone, dimethoxyethane and tetrahydrofurane. Ion sizes of said electrolytes fit the pore sizes of said nanoporous carbon powder.

Some exemplary polymers having good anti-corrosive properties especially in the media of the electrolytes mentioned above include polyimide or polyvinylidene difluoride containing polymers or co-polymers.

According to various embodiments, a second surface of the metal substrate 44 of the metal current collector layer 42 that has not been fused with conductive carbon particles 46 or that has not been covered with the nanoporous carbon layer 48 can be encapsulated with a protective layer 47. The protective layer 47 can be chemically and electrochemically stable and protective against electrochemical corrosion in the media of the organic electrolyte used. The protective layer 47 can be made of a polymer capable of adhering to the metal substrate 44. Preferably, especially in the media of specific organic electrolytes mentioned above and for metal parts made of aluminum, the polymer can include polyimide or polyvinylidene difluoride containing polymers or co-polymers. Such a protective layer can also be applied on an inner surface of the capacitor casing 32, the surface of the first capacitor terminal 34, and the surface of the second capacitor terminal 36. The application of the protective layer on these surfaces can increase working voltage of EDLC 30 and thus further increase the output power density and efficiency of the EDLC 30.

Referring back to FIG. 1, the casing 32 of the EDLC 30 can be sealed with a sealing material 52 at the first capacitor terminal 34 and at the second capacitor terminal 36. The first polarizable electrode set 40a can include a set of multi-layered positive electrodes 40 and the second polarizable electrode set 40b can also include a set of multi-layered negative electrodes 40. The metal current collector layers 42 of each of the positive electrodes 40 of the first polarizable electrode set 40a are electrically connected to the first capacitor terminal 34. The metal current collector layers 42 of each of the negative electrodes 40 of the second polarizable electrode set 40b are electrically connected to the second capacitor terminal 36.

As shown in FIG. 1, the positioning of the first polarizable electrode set 40a and of the second polarizable electrode set 40b within the casing 32 of the EDLC 30 is such that the nanoporous carbon layers 48 of each of the electrodes 40 of the first polarizable electrode set 40a and each of the electrodes 40 of the second polarizable electrode set 40b are facing one another. A porous separator 54 can be positioned between the oppositely facing nanoporous carbon layers 48. The porous separator 54 can be made of an ion-permeable but electron-insulating material.

Furthermore, as shown in FIG. 1, at least the nanoporous carbon layer 48 of each of the electrodes 40 and the porous separator 54 can be impregnated with an organic electrolyte 38. Preferably, the nanoporous carbon layers 48 of the electrodes 40 can include nanopores that are of a size sufficient for the ions of the organic electrolyte 38 to fit therein.

A method of fusing the conductive carbon particles 46 into the first surfaces of the metal substrate 44 by way of a local fusion process is described in more detail below. According to various embodiments, the local fusion method results in the controlled fusing of each carbon particle such that a controlled, particularly substantially uniform distribution of the fused particles over the surface of the metal substrate 44 can be provided.

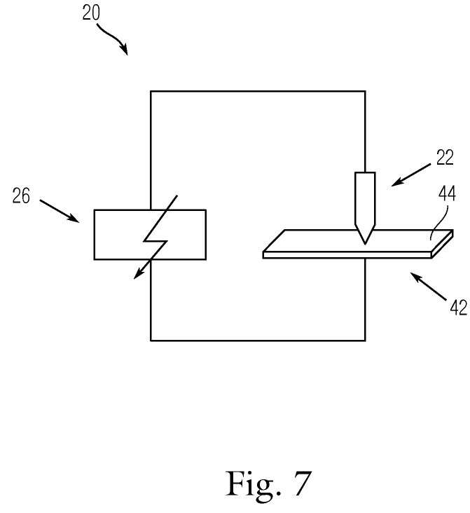

Referring to FIG. 7, an electric-spark device 20 is shown and can be used to partially fuse the conductive carbon particles 46 into the first surface of the metal substrate 44 of the metal current collector layer 42 by way of local fusion. The electric-spark device 20 can include an electric spark generator 26 and two electrodes, such as, for example, a carbon-containing electrode 22 and a metal substrate 44 of the metal current collector layer 42. Preferably, the carbon-containing electrode 22 acts as a positive electrode and the metal substrate 44 acts as a negative electrode. Changing a distance between the carbon-containing electrode 22 and the metal current collector layer 42 causes a short-term electric spark between these electrodes 22, 44. Within the inter-electrodal space, the short-term electric spark can spot melt one or more localized areas on the surface of the metal substrate 44 thereby causing the material of the metal substrate 44 to be flowable. The spark can also cause carbon particles from the carbon-containing electrode 22 to detach and form conductive carbon particles 46 and to cause each carbon particle 46 to become individually fused into the localized melted area of the metal substrate 42.

In one example, the carbon-containing electrode 22 is made of a graphite, carbon black, or acetylene black rod or disc that can oscillate in a perpendicular direction with respect to the metal substrate 44 to create the short-term electric spark. Additionally, during the electric spark fusing process, the carbon-containing electrode 22 and the metal substrate 44 can move in a predetermined pattern and speed such that each of the conductive carbon particles 46 can be separately and individually fused into the metal current collector layer 42 in a predetermined spaced relationship to one another.

In an alternative method of fusing the conductive carbon particles 46 into the surface of the metal substrate 44 by local fusion, a conductive layer of carbon-containing material can first be applied onto the surface of the metal substrate 44. Particles of the conductive carbon-containing material can then be partially fused into the surface of the metal substrate 44 using the electric spark device 20. In this alternative method, the conductive layer of carbon-containing material includes a mixture of the conductive carbon-containing material, such as graphite, carbon black, or acetylene black, and a binder such as polymer, and/or resin. The mixture is applied on the surface of the metal substrate 44 and is used as one of the electrodes in the electric spark device 20. During the sparking process, the spark can cause the conductive carbon-containing material to decompose and form carbon particles that are separately and individually fused into the surface of the metal current collector layer 42. Once the sparking process is completed, the remaining material of the mixture can be removed.

Each of the conductive carbon particles 46 can also be locally fused into the surface of the metal current collector layer 42 using a laser beam. When using a laser beam, the conductive carbon particles can be deposited onto the surface of the metal substrate 44, as described above, and then individually treated with the laser beam. Alternatively, the conductive carbon particles can be injected into the path of a laser beam that is focused on the surface of the metal substrate 44.

Alternatively, the metal current collector layer 42 can be roughened by a mechanical and/or chemical process to partially reduce negative effect of the oxide film. For example, the metal current collector layer 42 can be roughened by rolling emery paper or by etching, or by any other method as would be appreciated by one of ordinary skill in the art.

Partially fusing the conductive carbon particles 46 into the surface of the metal substrate 44 by the local fusion process of the present teachings can be substantially more technically advantageous and cost-effective compared to mechanically pressing and/or fitting the conductive carbon particles 46 into the surface of the metal substrate 44. Moreover, the local fusion process of the present teachings allows a user to locally and individually fuse each of the conductive carbon particles 46 into the surface of the metal substrate 44 thereby providing a controlled distribution of the conductive carbon particles 46.

### EXAMPLES

### Example 1

A nanoporous carbon powder, FILTRASORB-400 (available form Calgon Carbon Corp. of Pittsburgh, Pa., U.S.A.), produced from a natural bituminous coal was milled, suspended in a hot aqueous solution of oxalic acid and stirred for 2 hours. The suspension was then filtered and washed with a diluted solution of oxalic acid and dried. The washed product was heated for 2 hours under inert atmosphere at 850° C. in an oven to obtain a nanoporous carbon powder. The FILTRASORB-400 and the obtained nanoporous carbon powder were analyzed for total ash content and iron content in the ash. The latter was then recalculated to determine the iron content in the FILTRASORB-400 and in the obtained activated carbon powder. The obtained results are shown below:

| | Ash, wt % | Fe, wt % |
|---|---|---|
| FILTRASORB-400 | 5.5 | 0.36 |
| Obtained Activated Carbon | 5 | 0.12 |
| Powder | | |

From experimental data on sorption/desorption of nitrogen gas using an ASAP 2000M unit (available from Micromeritics of Norcross, Ga., U.S.A.), it was determined that the obtained nanoporous carbon powder includes a total pore surface area of 1053 m²/g and an average pore diameter of 1.7 nm.

### Example 2

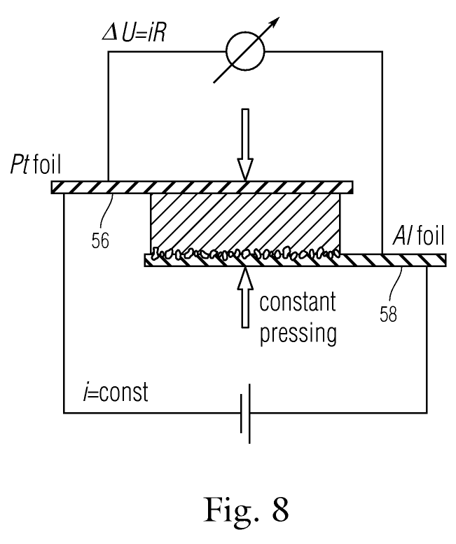

Plain aluminum foil having a thickness of 10 microns was used as a negative electrode in an electric spark device under atmospheric pressure. A graphite rod was used as a positive electrode to fuse graphite particles into the aluminum foil (metal substrate 44, FIG. 2) to create a modified aluminum foil.(metal current collector layer 42) The obtained nanoporous carbon powder of Example 1 was mixed with a binder having 10 wt. % of polyvinylidene difluoride (PVDF). The mixture was then applied to the surface of the modified aluminum foil using doctor blade technique to create a nanoporous carbon layer 48 (FIG. 5). The nanoporous carbon layer on the surface of the modified aluminum foil was then dried and its thickness was measured to be about 100 microns. Using a four-connection method device, the resistance of the polarizable electrode was calculated by measuring a voltage drop between points 56 and 58, shown in FIG. 8. The results of voltage drop are presented in Table 2, line 1.

### Example 3

An aluminum foil having a thickness of about 60 micron was modified by fusing graphite particles in the same manner as described in Example 2. The obtained nanoporous carbon powder of Example 1 was mixed with a polytetrafluoroethylene (PTFE) binder, the binder content in the mixture being about 7 wt. %. The mixture was then rolled and pressed on the surface of the modified aluminum foil to form a flat nanoporous carbon layer having a thickness of about 100 microns. The resistance of the polarizable electrode was measured using the four-connection method device as described in Example 2. The results of measurements of the polarizable electrode resistance are presented in Table 1, line 1 and in Table 2, line 2.

### Example 4

An aluminum foil having a thickness of about 20 microns was modified by fusing graphite particles in the same manner as described in Example 2. An nanoporous carbon powder having a thickness of about 100 microns was made in the same manner as described in Example 3. A 3 micron thick layer of acetylene black having 20 wt. % of PVDF binder was spread and dried on the surface of the modified aluminum foil to form a conductive primary coating (conductive layer 50, FIG. 5). The nanoporous carbon powder was then applied to the primary coating to form a polarizable electrode. The resistance of the polarizable electrode was measured using the four-connection method device in the same manner as described in

### Example 2. The results of the measurements of the polarizable electrode resistance are presented in Table 2, line 3.

### Example 5

The surface area of an aluminum foil having a thickness of about 60 microns was covered with a thin layer of a mixture of carbon black and polyvinyl alcohol as a binder. The layer of mixture of carbon black and binder was dried and treated under an inert atmosphere with laser beam shots that were perpendicular to the surface of the aluminum foil to form a modified aluminum foil. The primary coating of Example 4 and the nanoporous carbon layer having a thickness of about 100 microns thick of Example 3 were applied to the surface of the modified aluminum foil. The resistance of the polarizable electrode was measured using the four-connection method device in the same manner as described in Example 2. The results of the measurements of the polarizable electrode resistance are presented in Table 2, line 4.

### Example 6

A few EDLC prototypes were manufactured using the polarizable electrodes of Example 4. The dimensions of each of the polarizable electrodes were 50×30 mm. Additionally, the nanoporous carbon layer of the polarizable electrode was about 0.1 mm thick. Five positive polarizable electrodes and five negative polarizable electrodes were correspondingly electrically connected in parallel. A thin porous separator was positioned between the positive polarizable electrodes and the negative polarizable (i.e., electrodes with a nanoporous carbon powder layer facing one another as illustrated schematically in FIG. 1.) The polarizable electrodes and the separator were impregnated with an organic electrolyte containing 1 mol/l of triethylmethylammonium tetrafuoroborate and 0.3 mol/l of tetrakis(dimethylamino) phosphonium tetrafuoroborate in acetonitrile and then hermetically sealed inside a casing made of an aluminum foil laminated with polypropylene. Each of the EDLC prototypes had a capacitance of about 21 F, a DC resistance of about 9 mOhm, and a time constant as low as 0.19 s.

### Example 7

An aluminum foil having a thickness of about 20 microns was modified by fusing graphite particles into both sides of the aluminum foil using the method as described in Example 2. Additionally, both sides of the modified aluminum foil were covered with a primary coating of Example 2. Nanoporous carbon layers were then applied to both sides of the modified aluminum foil using the method described in Example 4 to fabricate a few polarizable electrodes. Each of the polarizable electrodes had a dimension of 50×30 mm. The positive polarizable electrode had a nanoporous carbon layer thickness of about 0.10 mm and the negative polarizable electrode had a nanoporous carbon layer thickness of about 0.12 mm. Several EDLC prototypes were made using 13 positive polarizable electrodes and 13 negative polarizable electrodes that were correspondingly electrically connected in parallel. A porous separator was positioned between each of the positive and negative polarizable electrodes. The polarizable electrodes and the porous separator were impregnated with organic electrolyte containing 1 mol/l of triethylmethylammonium tetrafuoroborate and 0.3 mol/l of tetrakis(dimethylamino) phosphonium tetrafuoroborate in acetonitrile and hermetically sealed inside a casing made of an aluminum foil laminated with polypropylene. Each of the EDLC prototypes had a capacitance of about 55 F, a DC resistance of about 4 mOhm, and a time constant of as low as about 0.22 s.

Using the four-connection method device shown in FIG. 8, the voltage drop across the polarizable electrodes of Examples 2-5 was measured to determine the resistances of the polarizable electrodes. Using the four-connection method device, a constant current was passed across the aluminum foil, the nanoporous carbon powder, and a platinum foil pressed on the top of the nanoporous carbon layer. A drop in voltage occurred between points 56 and 58 of the four-connection method device. This voltage drop was measured by a high-resistance voltmeter. The total resistance of the polarizable electrode from the (i) contact point between the aluminum foil and the nanoporous carbon powder, R_{Al/C}, (ii) the nanoporous carbon powder itself, R_{C}, and (iii) the contact point between the nanoporous carbon powder and the platinum foil, R_{PT/C}, were calculated by measuring the total resistance at various nanoporous carbon powder thicknesses and replacing the aluminum foil with another platinum foil. The results of the measurements are listed in Tables 1 and 2. Additionally, for comparison purposes, results for polarizable electrodes fabricated from known methods and known carbon materials are presented in Tables 1 and 2.

The results presented in Table 1 show that the obtained low-cost nanoporous carbon powder based on bituminous coal and prepared by the method as described in Example 1 includes low electrical resistance compared with materials as presently used in EDLCs.

As shown in Table 2, No. 5, the use of a plain aluminum foil as a metal current collector layer results in a very high contact resistance (up to 2 Ω.cm²). As shown in Table 2, No. 6, a roughened metal collector surface having an increased contact surface area reduces the contact resistance to 0.6 Ω.cm². However, a resistance of 0.6 Ω.cm² is high for high power applications. Fusing high-conductive carbon particles into the metal substrate significantly reduces the contact resistance.

TABLE 1
Resistivity of nanoporous carbon powder made of different
porous carbon powders under the same conditions

| | Electrode resistivity, |
|---|---|
| Nanoporous carbon material | Ω · cm |
| Active Carbon Powder of Example 1 | 1.80 |
| SUPER-30 nanoporous carbon produced by Norit | 3.90 |
| (comparative example) | |
| Nutshell based activated carbon | ~20 |
| (comparative example) | |

TABLE 2
Resistivity of polarizable electrodes fabricated by different methods

| | | | Contribution to the |
|---|---|---|---|
| | | Total | total resistivity from |
| | Method for polarizable | resistivity, | Al/C contact |
| No. | electrode fabrication | Ω · cm² | resistance, Ω · cm² |
| 1 | Method of Example 2 | 0.13 (±0.02) | 0.06 (±0.02) |
| 2 | Method of Example 3 | 0.09 (±0.01) | 0.03 (±0.01) |
| 3 | Method of Example 4 | 0.07 (±0.01) | <0.01 |
| 4 | Method of Example 5 | 0.07 (±0.01) | <0.01 |
| 5 | Carbon electrode with PVDF | 1.1 ÷ 2.1 | 1 ÷ 2 |
| | spread on a plain Al foil | | |
| | (comparative example) | | |
| 6 | Carbon electrode with PTFE | 0.7 (±0.2) | ~0.6 |
| | pressed to a roughened Al foil | | |
| | (comparative example) | | |

### Example 8

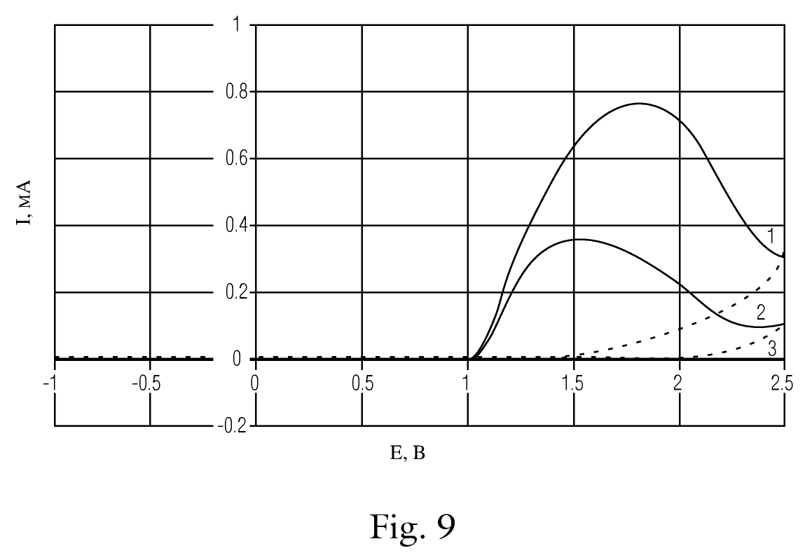

FIG. 9 is a graph of cyclic voltammetry curves of three EDLCs. The scanning rate for the graph was 10 mV/s. The electrolyte of each of the EDLCs was 0.1 M (C₂H₅)₄NBF₄ in acetonitrile. The polarizable electrode in each of the EDLCs included an aluminum plate having a surface area of 1 cm² with carbon black particles fused into the aluminum plate in the same manner as described in Example 2. Curve 1 of FIG. 9 represents a polarizable electrode in an EDLC that included a metal current collector layer without a polymeric protective layer. Curve 2 of FIG. 9 represents a polarizable electrode in an EDLC that included a metal current collector layer with about 50% of its surface area being protected by a PVDF protective layer. Curve 3 of FIG. 9 represents a polarizable electrode in an EDLC that included a metal current collector layer with its entire surface area being protected by a PVDF protective layer. According to Curve 1 of FIG. 9, aluminum corrosion was significant in an anodic region when no protective layer was used. The interaction of aluminum ions with tetrafluoroborate ions in the electrolyte and aluminum oxide film that naturally exists on the aluminum surface formed aluminum oxyfluorides. As shown in curves 2 and 3 of FIG. 9, the application of the PVDF protective layer reduced the corrosion of the metal current collector layer.

### Example 9

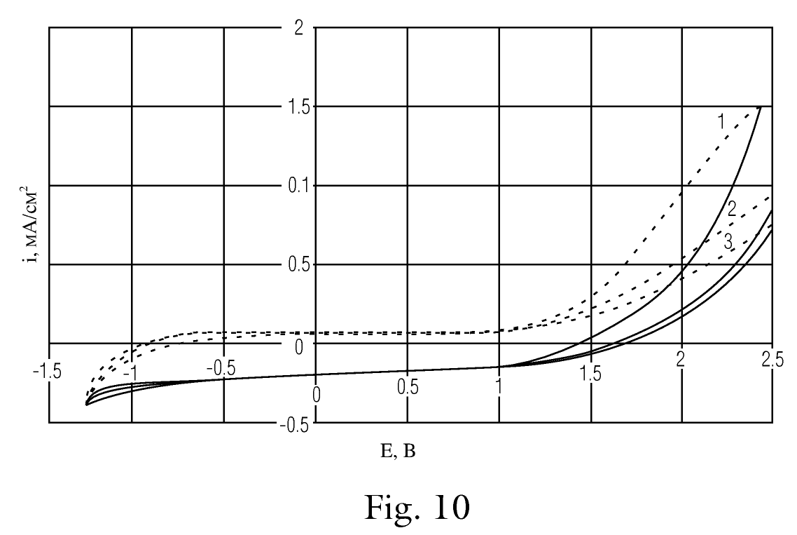

FIG. 10 is a graph of cyclic voltammetry curves of three EDLCs. The scanning rate for the graph was 10 mV/s. The electrolyte of each of the three EDLCs was 0.1 M (C₂H₅)₄NBF₄ in acetonitrile. The polarizable electrode in each of the EDLCs included an aluminum plate having a surface area of 1 cm² with carbon black particles fused into the aluminum plate in the same manner as described in Example 2. Curve 1 of FIG. 10 represents a polarizable electrode in an EDLC that included a metal current collector layer without a conductive protective layer. Curve 2 of FIG. 10 represents a polarizable electrode in an EDLC that included a metal current collector layer with about 50% of its surface area being protected by a mixture of 50 wt. % PVDF and 50 wt. % carbon black. Curve 3 of FIG. 10 represents a polarizable electrode in an EDLC that included a metal current collector layer with its entire surface area being protected by a mixture of 50 wt. % PVDF and 50 wt. % carbon black. According to Curve 1 of FIG. 10, aluminum corrosion was significant. As shown in curves 2 and 3 of FIG. 10, the application of a protective layer including a mixture of 50 wt. % PVDF and 50 wt. % carbon black reduced the corrosion of the metal current collector layer.

### Example 10

Five positive polarizable electrodes and five negative polarizable electrodes including an aluminum plate having a surface area of 1 cm² with carbon black particles fused into the aluminum plate were made in the same manner as described in Example 2. Each of the aluminum plates with fused carbon black particles were then covered with a conductive protective layer including PVDF and carbon black. The percentage of the carbon black present in each of the samples is shown in Table 3. Each of the polarizable electrodes having the conductive protective layer were used to make an EDLC. The electrolyte in each of the EDLCs was 0.1 M (C₂H₅)₄NBF₄ in acetonitrile. The resistivity of each of the polarizable electrodes was measured and shown in Table 3.

TABLE 3
Resistivity of a composite protective film as a function
of carbon black content

| | Content of carbon black | Resistivity of composite |
|---|---|---|
| | in composite polymer film, | polymer film, |
| Sample | % wt | Ohm · cm |
| 1 | 80 | 0.13 |
| 2 | 60 | 0.13 |
| 3 | 50 | 0.15 |
| 4 | 30 | 2.19 |
| 5 | 10 | >10 |

According to Table 3, the content of carbon black in the conductive protective layer should be from about 20 wt. % to about 80 wt. %, preferably between 30 wt. % and 60 wt. %—e.g., see the results of measurements in Table 3 above.

### Example 11

An aluminium foil having a thickness of about 20 microns was modified in a same manner described in Example 2. However, the graphite particles were fused into both surfaces of the aluminium foil. A flat nanoporous carbon layer having a thickness of about 100 microns was made in the same manner as described in Example 3. A slurry containing 50 wt. % of carbon black and 50 wt. % of PVDF was prepared in dimethylacetamide using an ultrasonic mixer. A thin layer of the slurry was first spread on one side of modified aluminium foil, dried, and then spread on the other side, and dried again. The modified aluminium foil covered with the slurry was then passed through a roller press to create a dense slurry coating having a thickness of about 5 microns. The nanoporous carbon layer was then applied to the coating on both sides of the modified aluminium foil. The remaining surfaces of the aluminium foil, which were not covered with the coating and the nanoporous carbon layer, were covered with a thin film of PVDF to make polarizable electrodes having a dimension of 50×30 mm. To make several EDLC prototypes, five positive polarizable electrodes and five negative polarizable electrodes made by the method described above were correspondingly connected in parallel. A thin porous separator was positioned between the positive polarizable electrodes and five negative polarizable electrodes (i.e., electrodes with nanoporous carbon powder layer facing one another as illustrated schematically in FIG. 1.) were impregnated with an organic electrolyte containing 1 mol/l of triethylmethylammonium tetrafuoroborate and 0.3 mol/l of tetrakis(dimethylamino) phosphonium tetrafuoroborate in acetonitrile and then hermetically sealed inside a casing made of aluminium foil laminated with polypropylene. Each of the EDLC prototypes had a capacitance of about 21 F, a DC resistance of about 9 mOhm, and a working voltage that was from about 0.3V to about 0.4V higher than that of prototypes made using the methods as described in Examples 6 and 7. (A working voltage was specified as the voltage at which a self-discharge current had a value of from about 1 to about 5 microAmpere per Farad).

Those skilled in the art can appreciate from the foregoing description that the present teachings can be implemented in a variety of forms. Therefore, while these teachings have been described in connection with particular embodiments and examples thereof, the true scope of the present teachings should not be so limited. Various changes and modifications may be made without departing from the scope of the teachings herein.

1. An electrochemical double layer capacitor comprising:
a casing;
a first multi-layered polarizable electrode and a second multi-layered polarizable electrode arranged within the casing, each multi-layered polarizable electrode including a nanoporous carbon layer and a metal current collector layer including a metal substrate having a first surface and a second surface, the first surface being covered by the nanoporous carbon layer;
a first capacitor terminal connected to the first multi-layered polarizable electrode;
a second capacitor terminal connected to the second multi-layered polarizable electrode; and
an organic electrolyte impregnating the nanoporous carbon layer;
wherein the first surface of the metal substrate includes a plurality of conductive carbon particles each (i) being locally and individually fused into the first surface of the metal substrate by spot melting an area on the first surface of the metal substrate, (ii) projecting out of the first surface, and (iii) surrounded by a flowed surface of the metal substrate; and
wherein the plurality of conductive carbon particles are at least one of graphite, carbon black, and acetylene black particles.

2. The electrochemical double layer capacitor of claim 1, wherein the nanoporous carbon layer is made of an activated carbon produced of a natural bituminous carbon material that has been treated by polycarboxilic acid, filtered, and heated.

3. The electrochemical double layer capacitor of claim 2, wherein the polycarboxilic acid is selected from one of oxalic acid, citric acid, and tartaric acid.

4. The electrochemical double layer capacitor of claim 2, wherein the nanoporous carbon layer is made of a powder including a plurality of nanoporous carbon particles having an average pore diameter of from about 1 nm to about 3 nm.

5. The electrochemical double layer capacitor of claim 1, further including a conductive layer arranged on the first surface of the metal substrate, the conductive layer being made of a binder and a highly conductive carbon powder including at least one of graphite powder, carbon black, and acetylene black.

6. The electrochemical double layer capacitor of claim 5, wherein the binder is a chemically and electrochemically stable polymer capable of (i) adhering to the metal current collector layer and the nanoporous carbon layer, and (ii) protecting the first surface of the metal substrate against electrochemical corrosion.

7. The electrochemical double layer capacitor of claim 5, wherein the content of the highly conductive carbon powder in the conductive layer is between about 20 wt. % and about 80 wt. %.

8. The electrochemical double layer capacitor of claim 6, wherein each second surface of the metal substrate, surfaces of the terminals inside the casing, and an inner surface of the casing are covered with a chemically and electrochemically stable film of a polymer capable of adhering to the covered items and protecting against electrochemical corrosion.

9. The electrochemical double layer capacitor of claim 1, wherein the organic electrolyte is based on tetrakis(dialkylamino)phosphonium or tetraalkylammonium tetrafluoroborates or hexafluorophosphates or their mixtures dissolved in a polar aprotic solvent or in the mixture of solvents selected from nitrites (acetonitrile, propionitrile, 3-methoxy propionitrile), lactones (γ-butyrolactone, γ-valerolactone), carbonates (propylene carbonate, ethylene carbonate, ethyl methyl carbonate), N,N-dimethylformamide, 1-methyl-2-pyrrolidinone, methyl ethyl ketone, dimethoxyethane and tetrahydrofurane.

10. The electrochemical double layer capacitor of claim 8, wherein each of the metal substrates, the terminals, and the casing are made of aluminum, and said polymer includes at least one of polyimide and polyvinylidene difluoride containing polymers or co-polymers.

11. The electrochemical double layer capacitor of claim 1, wherein the plurality of conductive carbon particles are locally and individually fused by one of an electric spark technique and a laser beam technique.

12. An electrochemical double layer capacitor comprising:
a casing;
a first multi-layered polarizable electrode and a second multi-layered polarizable electrode arranged within the casing, each multi-layered polarizable electrode including a nanoporous carbon layer and a metal current collector layer including a metal substrate having a first surface and a second surface, the first surface being covered by the nanoporous carbon layer;
a first capacitor terminal connected to the first multi-layered polarizable electrode;
a second capacitor terminal connected to the second multi-layered polarizable electrode; and
an organic electrolyte impregnating the nanoporous carbon layer,
wherein the nanoporous carbon layer is made of an activated carbon produced of a natural bituminous carbon material that has been treated by polycarboxilic acid, filtered, and heated.

13. The electrochemical double layer capacitor of claim 12, wherein the polycarboxilic acid is one of oxalic acid, citric acid, and tartaric acid.

14. The electrochemical double layer capacitor of claim 12, wherein the nanoporous carbon layer is made of a powder including a plurality of nanoporous carbon particles having an average pore diameter of from about 1 nm to about 3 nm.

15. The electrochemical double layer capacitor of claim 14, wherein each second surface of the metal substrate, surfaces of the terminals inside the casing, and an inner surface of the casing are covered with a chemically and electrochemically stable film of a polymer capable of adhering to the covered items and protecting against electrochemical corrosion.

16. The electrochemical double layer capacitor of claim 12, wherein the organic electrolyte is based on tetrakis(dialkylamino)phosphonium or tetraalkylammonium tetrafluoroborates or hexafluorophosphates or their mixtures dissolved in a polar aprotic solvent or in the mixture of solvents selected from nitrites (acetonitrile, propionitrile, 3-methoxy propionitrile), lactones (γ-butyrolactone, γ-valerolactone), carbonates (propylene carbonate, ethylene carbonate, ethyl methyl carbonate), N,N-dimethylformamide, 1-methyl-2-pyrrolidinone, methyl ethyl ketone, dimethoxyethane and tetrahydrofurane.

17. The electrochemical double layer capacitor of claim 15, wherein each of the metal substrates, the terminals, and the casing are made of aluminum, and said polymer includes at least one of polyimide and polyvinylidene difluoride containing polymers or co-polymers.

18. A metal current collector layer of an electrode comprising:
a metal substrate having a first surface and a second surface;
wherein at least the first surface of the metal substrate includes a plurality of conductive carbon particles each being locally and individually fused into the surface by spot melting an area on the first surface, the plurality of conductive carbon particles projecting out of the surface and being surrounded by a flowed surface of the metal substrate.

19. The metal current collector layer of claim 18, wherein the plurality of conductive carbon particles is at least one of graphite, carbon black, and acetylene black particles.

20. The metal current collector layer of claim 18, wherein the plurality of conductive carbon particles are locally and individually fused by way of one of an electric spark technique and a laser beam technique.

21. The metal current collector layer of claim 18, further comprising a conductive layer including a binder and a highly conductive carbon powder including one of a graphite powder, carbon black, and acetylene black, the conductive layer covering the first surface of the metal substrate that is fused with the plurality of conductive carbon particles.

22. The metal current collector layer of claim 21, wherein the content of the conductive powder in the conductive layer material is between about 20 wt. % and about 80 wt. %.

23. The metal current collector layer of claim 21, wherein the second surface of the metal substrate is covered with a chemically and electrochemically stable protective film of a polymer capable of adhering to the covered items and protecting against electrochemical corrosion.

24. The metal current collector layer of claim 23, wherein the metal substrate is made of aluminum foil, and the binder and the polymer of the protective film include at least one of polyimide and polyvinylidene difluoride containing at least one of polymers and co-polymers.
